(19) United States
(12) Patent Application Publication
(10) Pub. No.: US 2004/0017964 A1
(43) Pub. Date: Jan. 29, 2004

(54) Optical connector module, and optical system for infrared light

(75) Inventors: Tetsuhide Takeyama, Tokyo (JP); Takeshi Konada, Tokyo (JP)

Correspondence Address: John C. Altmiller, Esq., Kenyon & Kenyon, Suite 700, 1500 K Street, N.W., Washington, DC, 20005-1257, US

(73) Assignee: OLYMPUS OPTICAL CO., LTD., Tokyo (JP)

(21) Appl. No.: 10/391,769

(22) Filed: Mar. 20, 2003

(30) Foreign Application Priority Data
Mar. 26, 2002 (JP) 2002-085863

(51) Int. Cl. G02B 6/26

(52) U.S. Cl. 385/18

(57) ABSTRACT

The invention relates to an optical connector module that can accommodate well to a wide wavelength-band range and provide a high-precision connection by adjustment of only one lens. Operating to enter optical signals emerging from a plurality of input optical waveguides 10 and having a wavelength in the range of 1.2 μm to 1.7 μm in a plurality of output optical waveguides 20, the optical connector module uses one bilateral telecentric optical system 1 to provide optical connections of at least two light beams from the input optical waveguides 10 to the output optical waveguides 20.

This application claims benefit of Japanese Application No. 2002-85863 filed in Japan on Mar. 26, 2002, the contents of which are incorporated by reference.

### BACKGROUND OF THE INVENTION

The present invention relates generally to an optical connector module and an optical system for infrared light More specifically, the present invention is concerned with an optical connector module in the optical communications field, in which optical signals between a plurality of optical waveguides such as optical fibers are changeably connected together. The present invention is also directed to an optical system in the optical communications field, which is usable in the infrared range.

So far, modules for optical connection of optical waveguides such as optical fibers have been known typically from JP-B 62-39402 and JP-A's 5-107485 and 2001-174724. As set forth in the prior arts, one set of lenses is used per optical fiber.

On the other hand, an arrangement comprising one set of lenses for a plurality of optical fibers has been known typically from IEEE Photonics Technology Letters, Vol. 12, No. 7, pp. 882-884 (2000). The publication discloses an arrangement wherein what appears to be one telephoto optical system is located for two optical fibers of 2×2 optical switches.

Referring here to JP-A 2001-174724, there is proposed an optical cross-connect arrangement using an array of MEMS (Micro Electro-Mechanical Systems) gradient mirrors. This optical cross-connect arrangement is designed to selectively direct optical signals received from a plurality of input optical fibers to a plurality of output fibers, as schematically shown in FIG. 13. The optical cross-connect arrangement comprises an array of two-dimensionally arranged MEMS mirrors 420. This mirror array 420 comprises a plurality of gradient mirrors 420a to 420d. Each of the gradient mirrors 420a to 420d is mounted on a spring, and connected with an electrode for control by voltage. Each of the gradient mirrors 420a to 420d is of a rectangular, circular or elliptical shape of 100 to 500 μm in size. Each gradient mirror is rotated or inclined around an X-Y axis at an angle of inclination determined by the voltage applied on the associated electrode. In FIG. 13, one fiber array 410, one lens array 416 and one MEMS mirror array 420 are constructed in the form of a cross-connect arrangement while they lie one upon another. In this arrangement, the one fiber array functions as a combined input/output array. Incident on the lens array 416 via an optical fiber 414, an input signal 412 or incident light arrives on the MEMS mirror array 420a. Then, the light is reflected at a mirror 430, going back to the MEMS mirror array 420b. The light reflected at the MEMS mirror array 420b enters an output fiber 422 via the lens array 416, providing an output signal 424. In this arrangement, there is no distinction between an input port and an output port.

For optical connection wherein, as shown in FIG. 13, one set of lenses is used per fiber, high part processing accuracy is needed together with high assembling precision. That is, high precision is demanded for lens array-to-lens array spacing and axial alignment of each optical fiber with each lens array (shift and tilt). For a switch using an MEMS mirror array (the switching of light), the optical axes of an optical fiber and a microlens array must be in alignment with the center of an MEMS mirror with high accuracy. In some of prior art arrangements wherein one set of lenses is used for a plurality of optical fibers, details of those lenses and relations between a switching mirror array (an MEMS mirror array) and an optical fiber array have yet to be clarified.

None of the aforesaid conventional arrangements accommodate to a wide wavelength-band range. In the optical communications field, the amount of transmission is in such a direction as to be increased by WDM (wavelength division multiplexing). Some presently available wavelength bands add up to about 1.2 to 1.675 μm.

Optical connection should preferably address all the aforesaid wavelength bands. For currently available microlens arrays, etc., however, single lenses are in principle prevailing. Relief DOEs that can be fabricated with high accuracy by semiconductor processes are also usable.

### SUMMARY OF THE INVENTION

The present invention provides an optical connector module for optical communications, in which optical signals leaving a plurality of input optical waveguides with a wavelength ranging from 1.2 μm to 1.7 μm are entered in a plurality of output optical waveguides, characterized in that:

one bilateral telecentric optical system is used to optically connect at least two light beams from the input optical waveguides to the output optical waveguides.

The optical connector module of the present invention is also characterized in that a mirror array comprising a plurality of mirror elements with a variable angle of inclination is interposed to vary the direction of reflection of the light beams from the input optical waveguides by the variable angle-of-inclination mirror elements in the mirror array, thereby making changeable connection of the light beams to the output optical waveguides.

The optical connector module of the present invention is further characterized in that the mirror array comprising a plurality of mirror elements with a variable angle of inclination is located on a flat plate that is inclined with an angle with respect to the optical axis of the bilateral telecentric optical system.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is illustrative of the construction of the optical cross connect switch according to one embodiment of the invention.

FIG. 2 is illustrative of the construction of the optical cross connect switch according to another embodiment of the invention.

FIG. 3(a) is a front view of an MEMS mirror array comprising mirror elements arranged equidistantly in vertical and horizontal directions, and FIG. 3(b) is illustrative of apparent vertical and horizontal spacings between the mirror elements as viewed from its optical axis direction.

FIGS. 4(a) and 4(b) are illustrative of the construction of one specific embodiment of the invention wherein a bilateral telecentric anamorphic lens system is used in place of the bilateral telecentric optical system.

FIGS. 5(a) and 5(b) are illustrative of the construction of one specific embodiment of the optical cross connect switch where the end faces of optical fibers are obliquely cut to make NA non-isotropic.

FIG. 6 is illustrative of how an emergent light beam leaves the obliquely cut end face of an optical fiber.

FIGS. 7(a) and 7(b) are illustrative of how optical fibers are arranged in close contact with one another in an optical fiber array.

FIG. 8 is illustrative of the construction of one specific embodiment of the invention wherein a bilateral telecentric optical system is used for optical connection of an optical fiber array to a waveguide plate.

FIG. 9 is an optical path diagram for the telecentric optical system according to Numerical Example 1.

FIG. 10 is an optical path diagram or the telecentric optical system according to Numerical Example 2.

FIG. 11 is an aberration diagram for Numerical Example 1 at the image plane.

FIG. 12 is an aberration diagram for Numerical Example 2 at the image plane.

FIG. 13 is illustrative of one conventional optical cross connect arrangement known in the art.

### DESCRIPTION OF THE PREFERRED EMBODIMENTS

The present invention includes the following embodiments.

The optical connector module of the present invention is characterized in that the aforesaid bilateral telecentric optical system is defined by an anamorphic optical system whose magnification varies in directions that are orthogonal to its optical axis and to each other.

The optical connector module of the present invention is characterized in that in at least one of the aforesaid input optical waveguides or the aforesaid output optical waveguides, the waveguides are packed at a maximum packaging density.

The optical connector module of the present invention is characterized in that in at least one of the input optical waveguides or the output optical waveguides, the end faces of the optical waveguides are cut obliquely at an angle with respect to their optical axes to define slopes while the mirror array is inclined with respect to the slopes, wherein the mirror array is located at an angle of about 90° that the slopes make with the plane of the mirror array.

The present invention also provides an optical system for infrared light used in a wavelength range of 1.2 μm to 1.7 μm, characterized by using at least two different vitreous materials, one of which satisfies condition (1) with respect to ν₁, and another of which satisfies condition (2) with respect to ν₂;

70<ν₁<120 (1)

120<ν₂<250 (2)

where ν₁ and ν₂ are the Abbe number-equivalent values for the materials at 1.55 μm wavelength and defined by

ν=(n_{1.56}−1)/(n_{1.26}−n_{1.675}) (a)

where n_{1.26} is a refractive index at 1.26 μm wavelength, n_{1.675} is a refractive index at 1.675 μm wavelength, and n_{1.55} is a refractive index at 1.55 μm wavelength.

The optical system for infrared light according to the present invention is also characterized by being a bilateral telecentric optical system.

Embodiments of the optical connector module of the present invention and the optical system for infrared light according to the present invention are now explained.

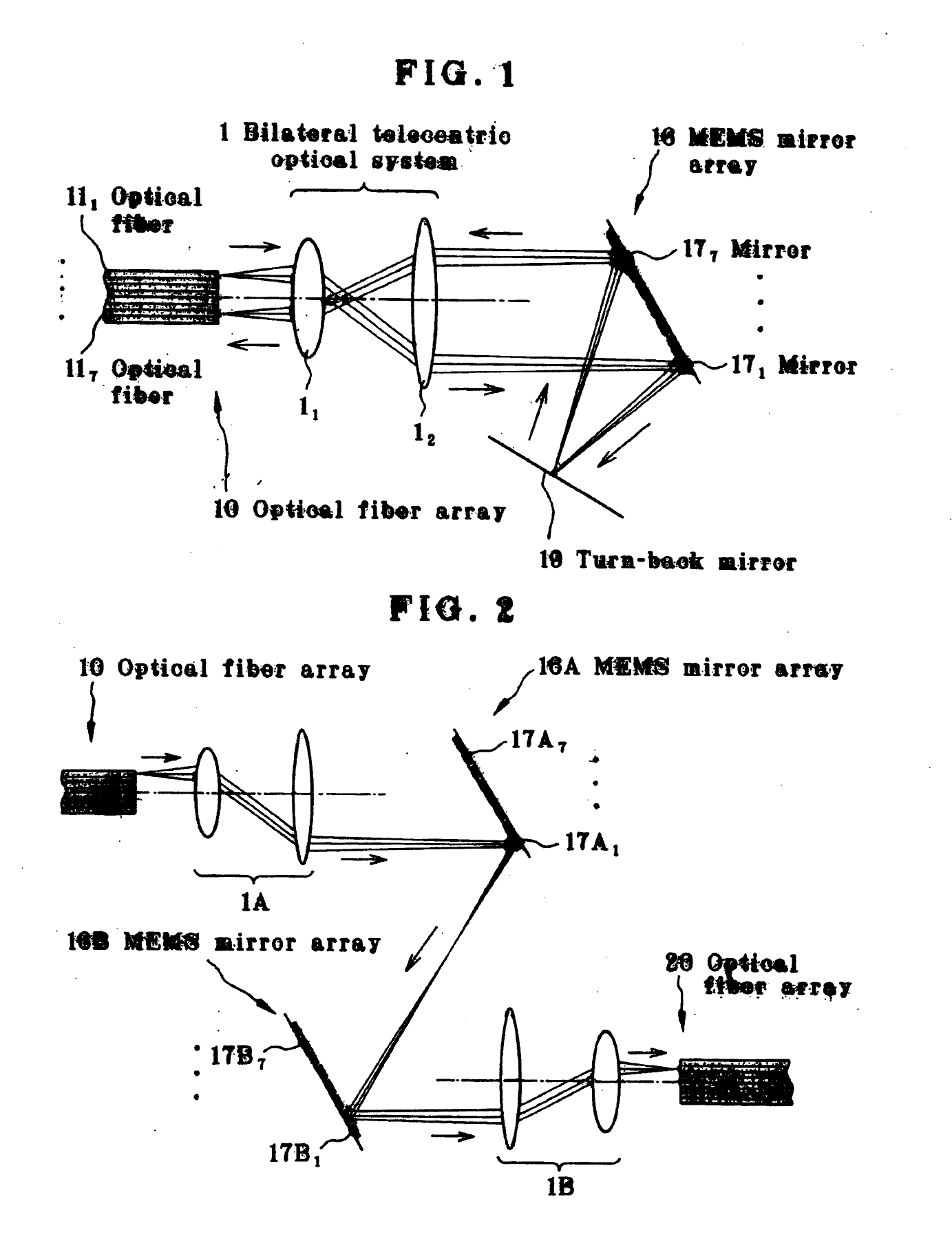

FIG. 1 is illustrative of the construction of the optical cross connect switch according to one embodiment of the present invention. In this embodiment, both the input and output optical waveguides are formed of optical fibers.

An optical fiber array 10 comprises optical fibers 11₁, . . . , 11₇. A bilateral telecentric optical system 1 having a magnification of 15× is located facing the end face of the optical fiber array 10. On the exit side of the bilateral telecentric optical system 1, an MEMS mirror array 16 is located in an inclined state. The optical fiber array 10 comprises a plurality of optical fibers 11₁, . . . , 11₇. Light is emergent from the end face of any of the optical fibers 11₁, . . . , 11₇. A light beam leaving that end face passes through the bilateral telecentric optical system 1, entering the MEMS mirror array 16. Upon incidence on the MEMS mirror array 16, the light beam is reflected at any of MEMS mirrors 17₁, . . . , 17₇ in the MEMS mirror array 16. A turn-back mirror (plane mirror) 19 is located at a (image-formation) position at which the reflected light beam is focused.

The bilateral telecentric optical system 1 used herein is defined by an optical system schematically comprising two positive lenses 11 and 12 located in confocal relations. The bilateral telecentric optical system 1 has the property of allowing a chief ray parallel incident on an optical axis shown by a one-dotted line to leave it parallel with the optical axis. Actually, this optical system is composed of two or more lenses, as can be seen from the numerical examples given later.

The MEMS mirror array 16 comprises MEMS mirror elements 17₁, . . . , 17₇ located in such a way as to align with the optical fibers in the optical fiber array 10. The MEMS mirrors 17₁, . . . , 17₇ are each mounted on a spring and connected with an electrode for control by voltage. Each mirror element is in a rectangular, circular, elliptical or other form. The MEMS mirrors 17₁, . . . , 17₇ are each inclined by an angle of inclination determined by the voltage applied on the electrode.

In such an arrangement as explained above, a light beam leaving the end face of one fiber in the optical fiber array 10, for instance, the optical fiber 11₁ is entered into the MEMS mirror 17₁ via the bilateral telecentric optical system 1. This MEMS mirror 17₁ in the MEMS mirror array 17 aligns with the optical fiber 11₁. Upon incidence on the MEMS mirror 17₁, the light beam is reflected at an angle depending on the angle of inclination of the MEMS mirror 17₁, and the reflected light forms an image on the turn-back mirror 19. Light reflected at the turn-back mirror 19 is then incident on the MEMS mirror 17₇ that corresponds to the angle of inclination of the MEMS mirror 17₁. Upon incidence on the MEMS mirror 17₇, the light beam is reflected at an angle depending on the angle of inclination of the MEMS mirror 17₇, entering the bilateral telecentric optical system 1. Going back through the bilateral telecentric optical system 1, the light beam forms an image on the end face of the optical fiber 11₇ in the optical fiber array 10. This optical fiber 11₇ corresponds to the angle of inclination of the MEMS mirror element 17₇. In this way, optical connection takes place. Thus, if the gradients of the MEMS mirrors 17₁ and 17₇ are controlled, optical connection can then be achieved in any desired combination of the optical fibers 17₁, . . . 17₇.

FIG. 2 is illustrative of the construction of the optical cross connect switch according to another embodiment of the present invention. In this embodiment, too, both the input and output optical waveguides are formed of optical fibers.

The optical fiber array 10 comprises optical fibers 11₁, . . . , 11₇. A bilateral telecentric optical system 1A having a magnification of 15× is located facing the end face of the optical fiber array 10. An MEMS mirror array 16A is located on the exit side of the bilateral telecentric optical system 1A while it is on the tilt. On the reflection side of the MEMS mirror 16A there is located an MEMS mirror array 16B; the MEMS mirror array 16A and the MEMS mirror array 16B are located while their reflecting surfaces are in a face-to-face fashion and arranged parallel with each other. On the reflection side of the MEMS mirror array 16B there is a bilateral telecentric optical system 1B having a magnification of 1/15. On the exit side of that MEMS mirror array, there is provided an optical fiber array 20.

In both the optical fiber arrays 10 and 20, individual optical fibers are arranged in much the same manner. The bilateral telecentric optical system 1A is identical to the bilateral telecentric optical system 1B, only with the exception that the direction of incidence of light is reversed. In both the MEMS mirror arrays 16A and 16B according to the same specifications, too, individual mirrors are arranged in much the same manner.

The optical fiber arrays 10 and 20, the bilateral telecentric optical systems 1A and 1B, and the MEMS mirror arrays 16A and 16B are positioned in such a way as to be 180° rotationally symmetric with respect to a given point. Specifically, that point is defined by the center of the turn-back mirror 19 in FIG. 1.

In this arrangement, a light beam emergent from the end face of a specific optical fiber in the optical fiber array 10 passes through the bilateral telecentric optical system 1A, entering the MEMS mirror array 16A. More specifically, the light beam enters the MEMS mirror in the MEMS mirror array 16A, which aligns with the aforesaid specific optical fiber. The incident light is then reflected at an angle depending on the angle of inclination of that MEMS mirror, and the reflected light temporarily forms an image between the MEMS mirror arrays 16A and 16B. Light passing through the image-formation point enters the MEMS mirror array 16B. To be more specific, that light enters an MEMS mirror in the MEMS mirror array 16B, which is at a position corresponding to the angle of inclination of the MEMS mirror in the MEMS mirror array 16A. The light beam is reflected at an angle depending on the angle of inclination of that MEMS mirror, entering the bilateral telecentric optical system 1B. Upon passing through the bilateral telecentric optical system 1B, the light beam forms an image on the end face of a specific optical fiber in the optical fiber array 20. This specific optical fiber is at an angle corresponding to the angle of inclination of the MEMS mirror in the MEMS mirror array 16B. In this way, optical connection takes place. Thus, if the gradients of the MEMS mirrors in the MEMS mirror arrays 16A and 16B are controlled, optical connection can then be carried out in any desired combinations of optical fibers in the optical fiber arrays 10 and 20.

From a comparison of FIG. 1 with FIG. 2, it is found that the arrangement of FIG. 1 is characterized in that the telecentric optical system is integrated into one single unit using the turn-back mirror 19. This feature enables the whole optical system to be made much more compacted. The arrangement of FIG. 2 is characterized by use of two telecentric optical systems 1A and 1B without recourse to any turn-back mirror. This feature ensures a doubling in the number of input/output channels despite the fact that the optical fibers (row×column) used in the optical fiber array 10, 20 are as many as those in FIG. 1. Thus, the whole size of the optical fiber array 10, 20 can be so diminished that some design advantages can be obtained.

Particular exemplary specifications of the arrangements shown in FIGS. 1 and 2 are given below.

Angle of the whole arrangement with respect to the optical axis of MEMS mirror array 16, 16A, 16B: 22.5°

Number of MEMS mirror elements: 8×8=64

Spacing between the MEMS mirror elements: δD=2.0295 mm (horizontal to the paper) 1.8750 mm (vertical to the paper)

Number of the optical fibers in the optical fiber array 10, 20: 8×8=64

Spacing between the optical fibers: δd=125 μm (the same as the diameter of an optical fiber cladding, both horizontal and vertical to the paper)

Magnification of the telecentric optical system 1, 1A: 15×

Magnification of the telecentric optical system 1B: 1/15×

Specific examples of the telecentric optical systems 1, 1A and 1B will be given later.

In a prior art arrangement using an MEMS mirror array (e.g., one set forth in JP-A 5-107485), the spacing between the optical fibers in an optical fiber array has to be identical with that between the mirror elements (MEMS mirror). The spacing between the mirror elements in the MEMS mirror array tends to become wide because of some fabrication problems and some optical problems. For these reasons, the prior art has difficulties in size reductions because the spacing between the optical fibers must be enlarged in alignment with the spacing between the mirror elements.

By contrast, if the bilateral telecentric optical systems 1, 1A and 1B having any arbitrary magnification as exemplified above are used, it is then possible to provide a solution to the aforesaid problem. In other words, even when the spacing between the mirror elements in the MEMS mirror array 16, 16A, and 16B is wide, the spacing between the optical fibers in the optical fiber array 10, and 20 can be narrowed. Thus, the use of the bilateral telecentric optical systems 1, 1A and 1B having varying magnifications (15×, 1/15× used herein) eliminates the need of making the spacing between the optical fibers equal to that between the MEMS mirror elements, ensuring an increase in the degree of design freedom.

While the bilateral telecentric optical system can have any desired magnification, there is no merit in making the spacing between the optical fibers wider than that between the MEMS mirror elements. For that reason, the bilateral telecentric optical system 1, 1A on the entrance side should preferably have a magnification of 1 or greater. In consideration of size reductions, however, the magnification should preferably be limited to 30× or less.

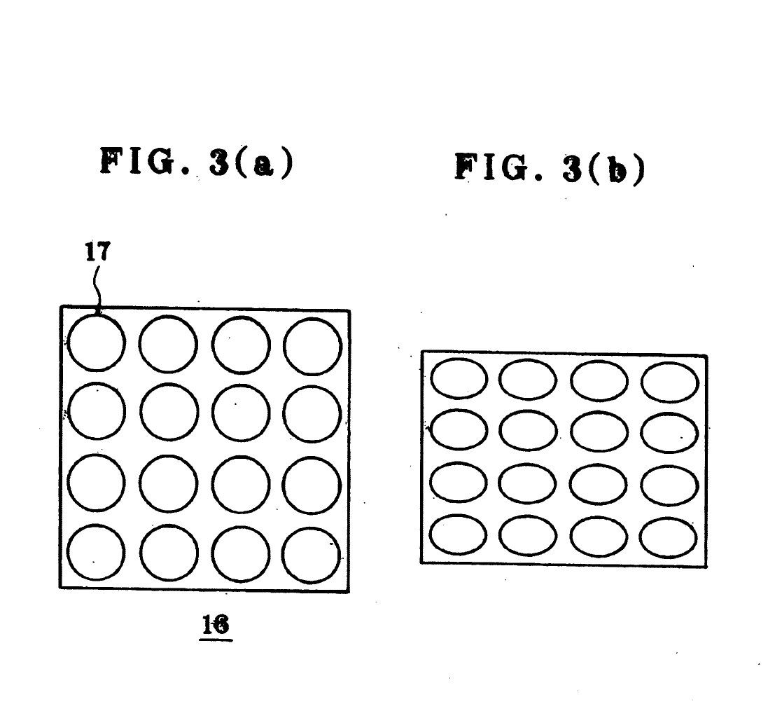

In the arrangements of the optical cross connect switch shown in FIGS. 1 and 2, suppose now that the optical fibers in the optical fiber array 10, 20 are arranged in an equidistant square lattice pattern. Also suppose that the MEMS mirrors 17 in the corresponding MEMS mirror array 16, 16A, 16B are arranged in an equidistant square lattice pattern as shown in FIG. 3(a). In the arrangement of FIG. 1 or FIG. 2, since the MEMS mirror array 16, 16A, 16B remains inclined with respect to the axial direction, the horizontal and vertical spacings between the MEMS mirrors 17 in the MEMS mirror array 16, 16A, 16B are not equal as viewed from the axial direction. As typically shown in FIG. 3(b), the horizontal spacing to the paper is different from the vertical spacing to the paper of FIGS. 1 and 2.

Making those different spacings equal to each other may be achieved by varying the spacings between the MEMS mirrors 17. However, some restrictions on the fabrication of the MEMS mirror array 16, 16A, 16B, cost problems, etc. do not often allow the vertical and horizontal spacings between the MEMS mirrors 17 to be freely set. According to one approach to that case, the vertical and horizontal spacings between the optical fibers in the optical fiber array 10, 20 may be varied in compliance with the apparent vertical and horizontal spacings shown in FIG. 3(b). With another approach, the bilateral telecentric optical system 1, 1A, 1B may be designed as a bilateral telecentric anamorphic lens system. For instance, this may be achieved by varying the (longitudinal/lateral) magnification of the optical system shown in FIG. 1 in the directions vertical and horizontal to the paper.

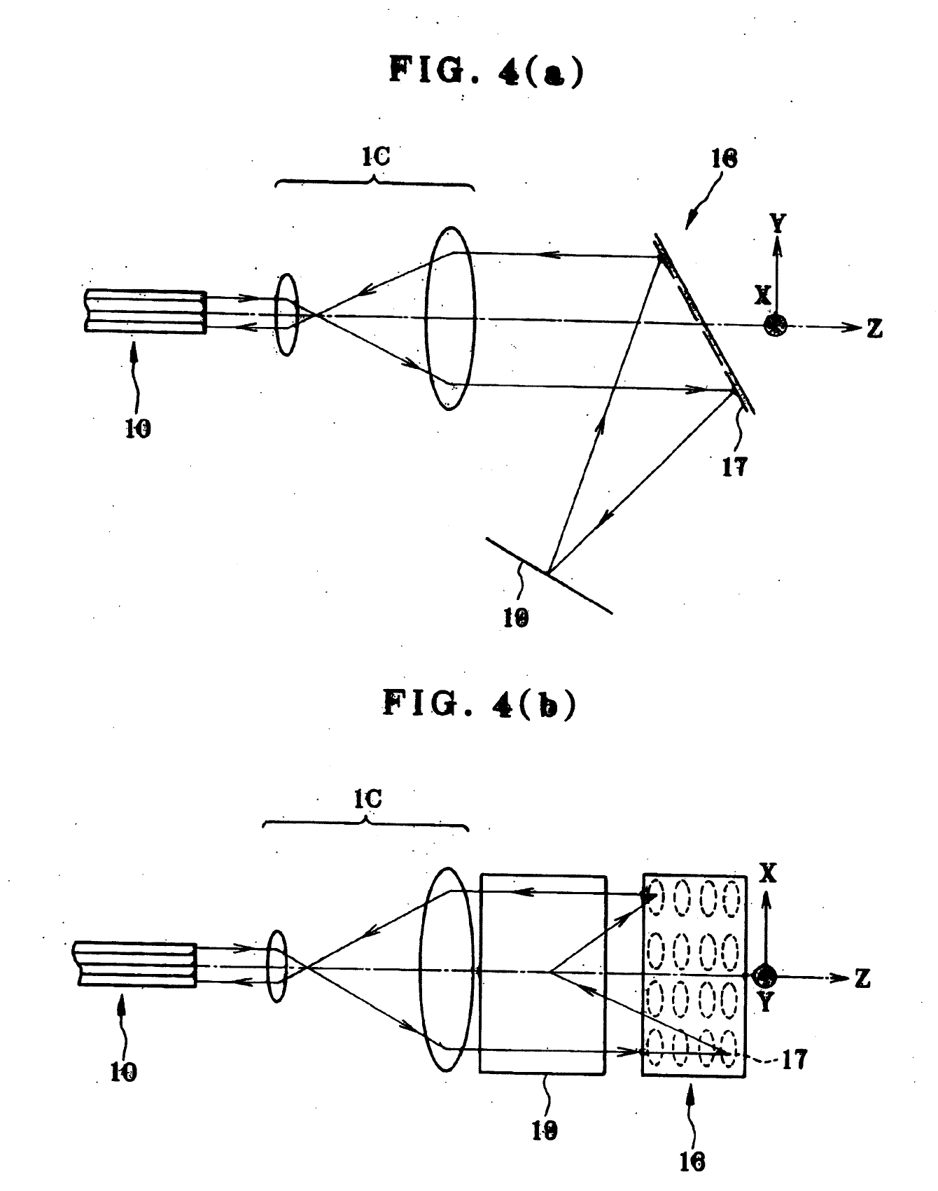

FIGS. 4(a) and 4(b) are illustrative of one arrangement using a bilateral telecentric anamorphic lens system. For simplicity, the “bilateral telecentric anamorphic lens system” will simply be called the “anamorphic lens system”. In the embodiment shown in FIGS. 4(a) and (b), an anamorphic lens system 1C is used instead of the bilateral telecentric optical system 1 of FIG. 1. FIG. 4(a) is an optical path diagram as projected onto the Y-Z plane and FIG. 4(b) is an optical path diagram as projected onto the X-Z plane, wherein the Z-axis is the axial direction. In this embodiment, optical fibers in an optical fiber array 10 are arranged in a vertically and horizontally equidistant square lattice pattern, and so are MEMS mirrors 17 in an MEMS mirror array 16. The MEMS mirror array 16 is mounted while inclined with respect to the optical axis. Accordingly, as the MEMS mirror array 16 is viewed from the axial direction, the apparent spacings between the MEMS mirrors 17 in the Y-axis direction are narrowed down. Correspondingly, the magnification of the anamorphic lens system 1C in the Y-Z sectional direction (FIG. 4(a)) is more reduced than that in the X-Z sectional direction (FIG. 4(b)), so that a light beam emerging from any of the optical fibers in the optical fiber array 10 can be entered into the MEMS mirror 17 (corresponding to that fiber). Otherwise, the arrangement of FIGS. 4(a) and 4(b) operates as in the arrangement of FIG. 1.

Referring back to the MEMS mirror array 16, 16A, and 16B, the shape of each MEMS mirror 17 is generally circular as shown in FIG. 3(a). This is to rotate the MEMS mirror around both the orthogonal XY axes with the same mechanical properties. Because the MEMS mirror array 16, 16A, and 16B is mounted while inclined with respect to the optical axis direction, the MEMS mirror 17 of circular shape assumes a (apparently) elliptical shape (as viewed in the axial direction) having a major axis in the X-axis direction (FIGS. 4(a) and 4(b)) as projected in the axial direction, as shown in FIG. 3(b).

When such an apparently elliptical MEMS mirror is used with the optical fiber array 10, it is preferable that a light beam leaving each optical fiber is efficiently entered and reflected at the MEMS mirror 17 in the following manner. Referring typically to the arrangement of FIG. 1, a light beam leaving the bilateral telecentric optical system 1 is assumed to be a light beam having a flat section in its major axis direction.

On the other hand, the magnification of the anamorphic lens system is inversely proportional to the numerical aperture (NA) of a light beam leaving the optical system 1. To obtain a light beam of an elliptical shape having a major axis in the X-axis direction (FIGS. 4(a) and 4(b)), the magnification of the anamorphic lens system 1C in the X-Z sectional direction (FIG. 4(b)) should thus be lower than that in the Y-Z sectional direction (FIG. 4(a)), contrary to the example of FIGS. 4(a) and 4(b)). By such determination of the longitudinal and lateral magnifications of the anamorphic lens system 1C, the sectional shape of the light beam incident on each MEMS mirror 17 in the MEMS mirror array 16 can be conformed to the same elliptical shape as the apparent shape of the MEMS mirror 17. It is consequently possible to make effective use of the area of the MEMS mirror 17 and achieve high efficient optical connection. It is here noted, however, that differences between the longitudinal and lateral magnifications of the anamorphic lens system 1C and changes in the vertical and horizontal spacings between the apparent MEMS mirrors 17 in the MEMS mirror array 16 must be taken into account. On the basis of these considerations, the vertical and horizontal spacings between the optical fibers arranged in the optical fiber array 10 and between the MEMS mirrors 17 arranged in the MEMS mirror 16 must be determined.

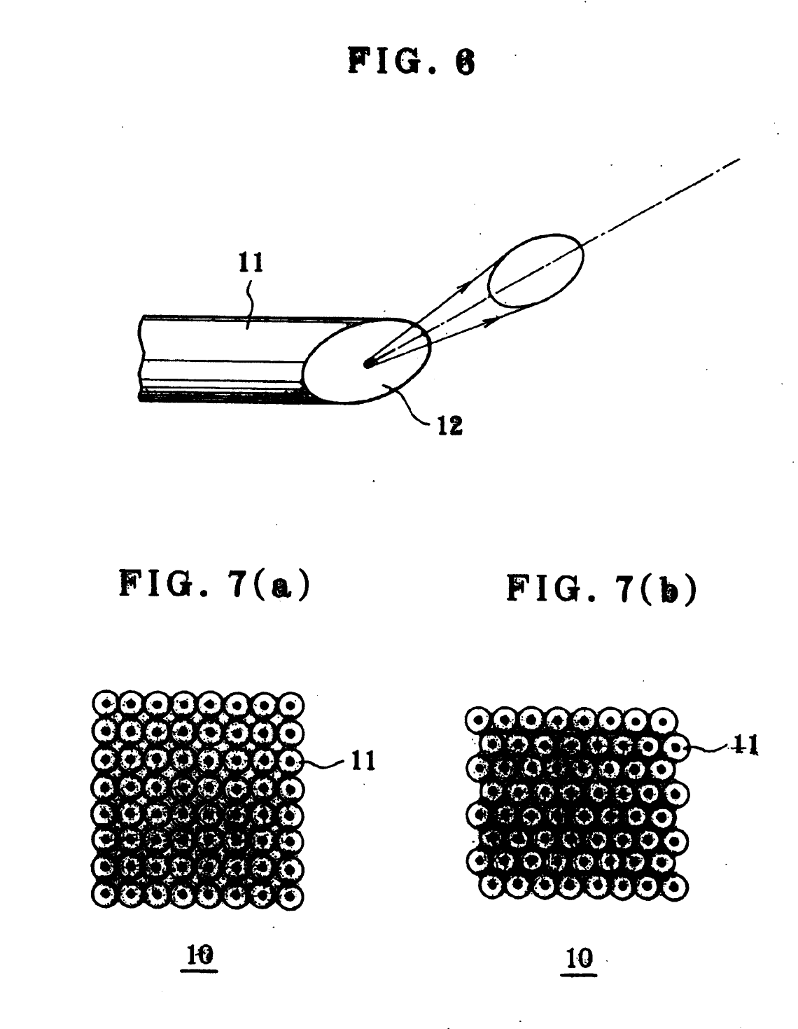

As schematically shown in FIG. 6, the end face of an optical fiber 11 may be cut obliquely with respect to its axis in such a way as to give a slope 12, for instance, with the normal being at an angle of about 8° with respect to that axis. This ensures that the optical axis of a light beam emerging from the optical fiber 11 is deflected along the slope 12 due to its refracting prism effect, and the angle of spreading (NA) of the light beam becomes large depending on the angle of deflection. In other words, the NA of the light beam becomes larger in the direction of deflection rather than isotropically. By harnessing this phenomenon, the light beam leaving each optical fiber in the optical fiber array 10 can efficiently be entered into and reflected at the apparently elliptical MEMS mirror 17.

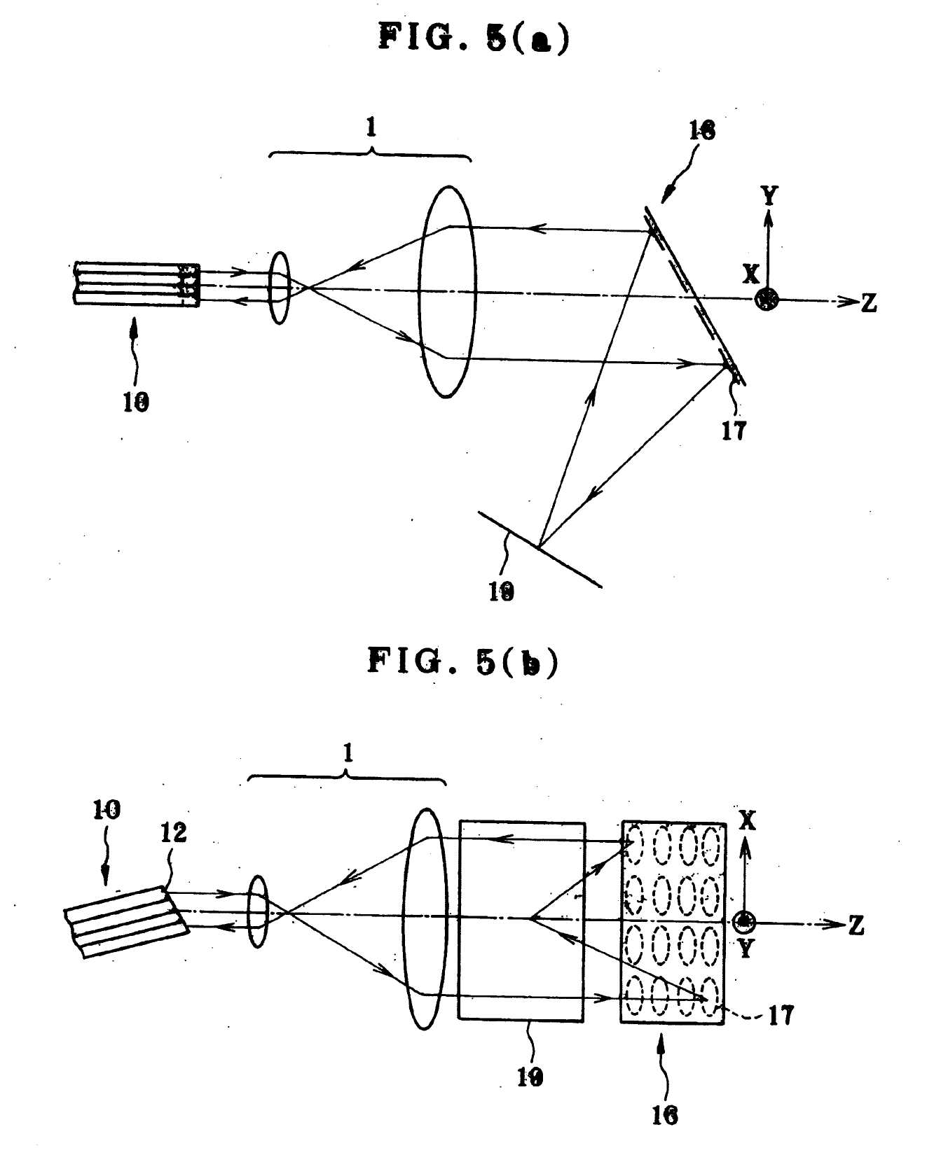

A specific example of this is shown in FIGS. 5(a) and 5(b). This example is the same as the example of FIG. 1 with the exception of the end face configuration and location of the optical fiber array 10. FIGS. 5(a) and 5(b) are optical path diagrams for the example as projected onto the Y-Z plane and upon projected onto the X-Z plane, respectively. The coordinates used herein are the same as in FIGS. 4(a) and 4(b). In this example, optical fibers are obliquely cut after bundled up into an optical fiber array 10. Then, the optical fiber array 10 is inclined and positioned within an X-Z section in such a way that a slope 12 is inclined in the X-Z section but not in a Y-Z section. Passing through a rotationally symmetric, bilateral telecentric optical system 1, a light beam from each optical fiber in the optical fiber array 10 is incident on each MEMS mirror 17 in an MEMS mirror array 16. On the basis of the aforesaid principles, the sectional shape of the light beam incident on the MEMS mirror 17 becomes much the same elliptical shape as the apparent shape of the MEMS mirror 17. It is consequently possible to make effective use of the area of the MEMS mirror 17 and achieve high efficient optical connection.

In the example of FIGS. 5(a) and 5(b), the individual optical fibers may be cut at their end faces before bundled into the optical fiber array 10. However, it is preferable to obliquely cut the optical fibers after bundled up into the optical fiber array 10, because of the merit that the directions of the end faces of the optical fibers can be put in order in one operation.

In this example, the end face of each optical fiber is cut obliquely with respect to its axis, and so it is unlikely that light reflected at the end face may go back to the input side. Thus, another merit of the arrangement of FIGS. 5(a) and 5(b) is to prevent the light reflected at the end face from making noises.

Two examples wherein the shape of the incident light beam is conformed to the apparent shape of the MEMS mirror 17 have been explained; one being directed to the use of the anamorphic lens system thereby configuring the incident light beam into an elliptical shape in section, and another to cutting the end face of each optical finger as a slope thereby configuring the incident light beam into an elliptical shape in section. In either case, it is preferable that the major axis of the elliptical light beam incident on the MEMS mirror 17 is in alignment with that of the apparently elliptical MEMS mirror 17. It is thus possible to make effective use of the area of the MEMS mirror 17. Then, the angle between both the major axes should be within 15°, preferably within 10°, and most preferably within 5°.

In the present invention, the bilateral telecentric optical system 1, 1A, 1B, and 1C having any desired magnification is used as exemplified above, and so it is not necessary to make the spacings between the optical fibers in the optical fiber array 10, 20 equal to the spacings between the MEMS mirrors in the MEMS mirror array 16, 16A, and 16B equal to each other. Hence, as shown in FIGS. 7(a) and 7(b), the spacings between the optical fibers 11 in the optical fiber array 10 can be identical with the cladding diameter of the optical fibers 11 (125 μm), so that the optical fibers can mutually be positioned while they are laid down row by row. In addition, since the optical fibers 11 are fabricated with cladding diameters having very high precision, they can be arranged at precise spacings. The optical fibers 11 may be either arranged in such a square lattice pattern as shown in FIG. 7(a), or packed at the maximum density as shown in FIG. 7(b). It is here noted that the MEMS mirrors 17 in the MEMS mirror array 16, 16A, and 16B should be arranged in conformity with the arrangement of the optical fibers 11 in the optical fiber array 10. The packing of the optical fibers at the maximum density as shown in FIG. 7(b) is naturally obtained, with the minimum sectional area, when the optical fibers 11 are two-dimensionally put in order. This packing ensures ease with which the optical fibers are arranged, and is advantageous for size reductions as well.

As can be understood from the specific examples given later, the bilateral telecentric optical system 1, 1A, 1B, and 1C should preferably accommodate well to a wide wavelength-band of 1.2 μm to 1.7 μm. To this end, it is required to use a plurality of vitreous materials for the bilateral telecentric optical system 1, 1A, 1B, and 1C thereby making satisfactory correction for chromatic dispersion.

Chromatic aberrations are well correctable by combined use of a vitreous material having high dispersion and a vitreous material having low dispersion. In Numerical Example 1 given later, two glass materials, i.e., glass 1 and glass 2 are used, and in Numerical Example 2 two glass materials, i.e., glass 1 and glass 3 are used. These glass materials have such refractive indices as tabulated below.

| Wavelength (nm) | 1675.00 | 1550.00 | 1460.00 | 1260.00 |
|---|---|---|---|---|
| Glass 1 | 1.758271 | 1.760827 | 1.762720 | 1.767294 |
| Glass 2 | 1.429464 | 1.430200 | 1.430722 | 1.431886 |
| Glass 3 | 1.485046 | 1.485973 | 1.486631 | 1.488103 |

Here the Abbe number equivalent value at 1.55 μm wavelength is given by ν defined as:

ν=(n_{1.55}−1)/(n_{1.26}−n_{1.675}) (a)

where n_{1.26} is a refractive index at 1.26 μm wavelength, n_{1.675} is a refractive index at 1.675 μm wavelength, and n_{1.55} is a refractive index at 1.55 μm wavelength.

The optical system for infrared light according to the present invention is used with infrared light in a wavelength range of 1.2 μm to 1.7 μm. For this optical system, at least two vitreous materials are used, one of which satisfies condition (1) with respect to an Abbe number-equivalent value ν₁ at 1.55 μm wavelength:

70<ν₁<120 (1)

and another of which satisfies condition (2) with respect to an Abbe number-equivalent value ν₂ at 1.55 μm wavelength:

120<ν₂<250 (2)

This enables chromatic aberrations to be well corrected in the wavelength range of 1.2 μm to 1.7 μm by a combination of refracting lenses without recourse to any diffracting optical device.

More preferably,

75<ν₁<115 (1-1)

120<ν₂<250 (2-1)

Even more preferably,

80<ν₁<115 (1-2)

125<ν₂<200 (2-2)

It is noted that the values of ν of glasses 1, 2 and 3 are 84.3, 177.6 and 159.0, respectively.

Further, if condition (3)

n₁>1.7 (3)

is satisfied provided that n₁ is the refractive index at 1.55 μm wavelength of a vitreous material having the Abbe number-equivalent value ν₁ at 1.55 μm wavelength, it is then possible to obtain an optical system with better corrected Petzval's sum and so on.

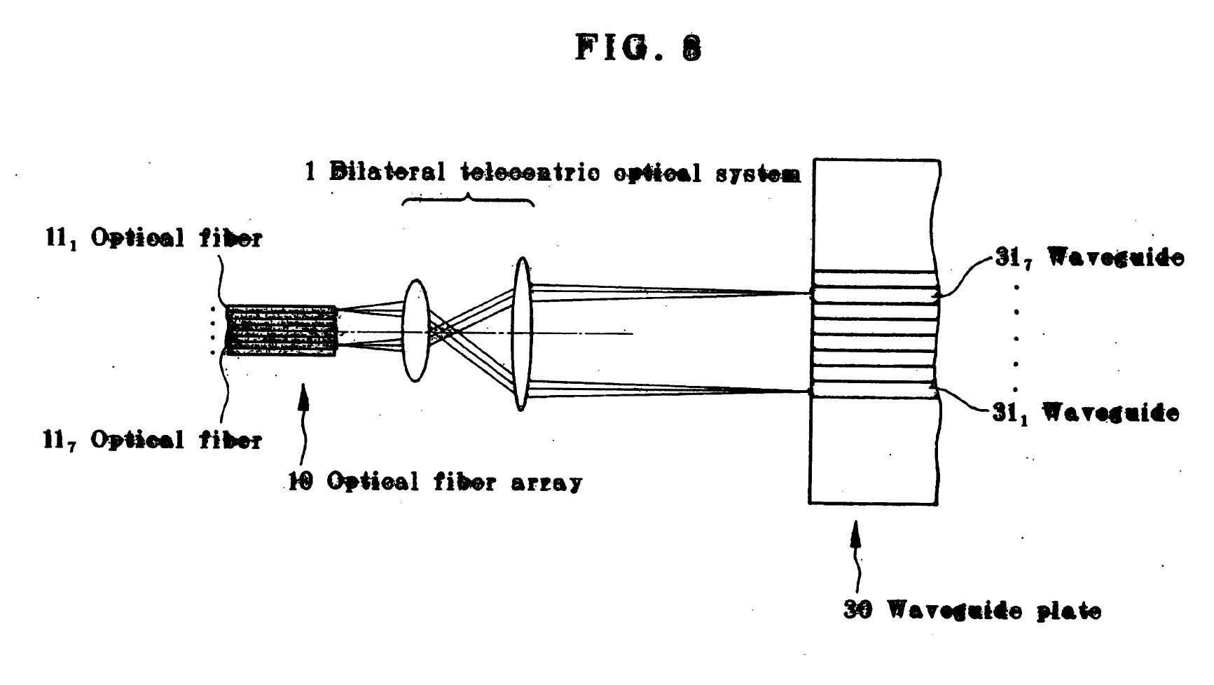

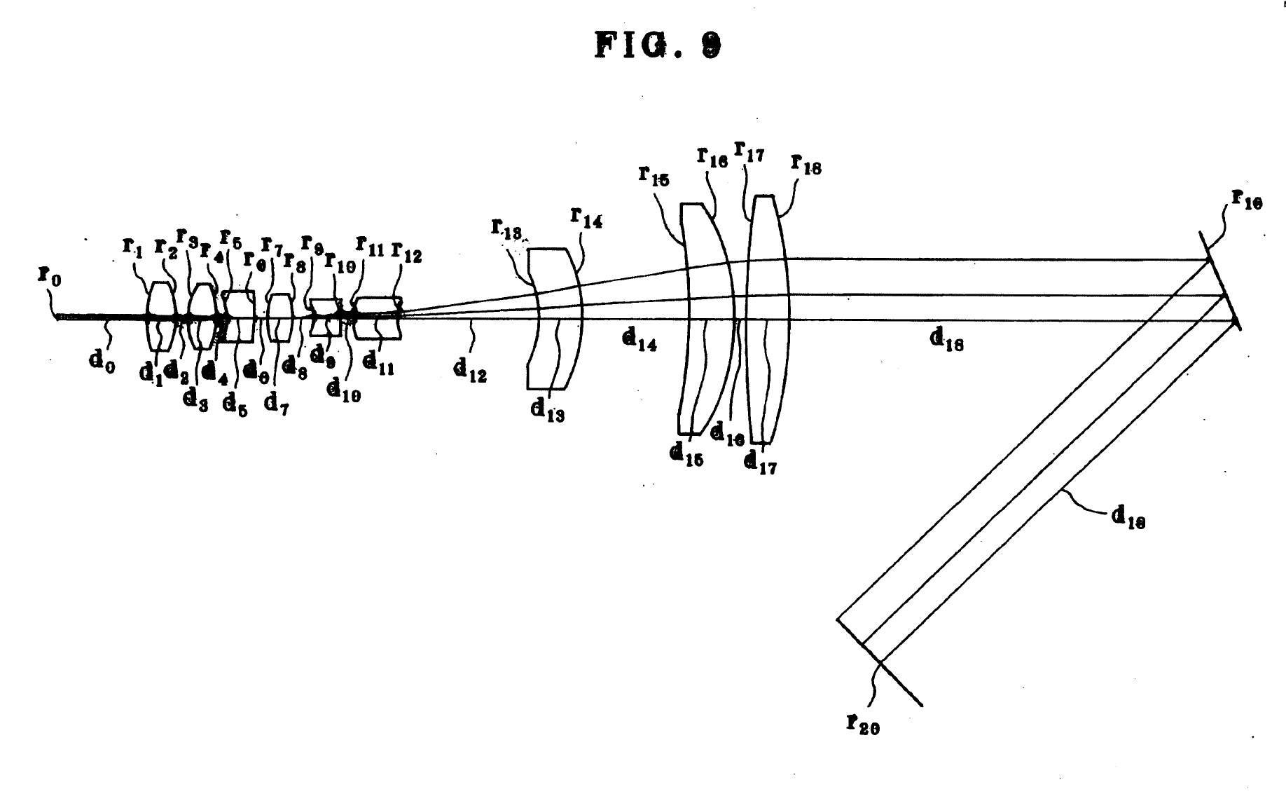

It is here understood that the application of the bilateral telecentric optical system 1, 1A, 1B, and 1C having any desired magnification is not necessarily limited to the optical cross connect arrangements of FIGS. 1, 2, 4, 5 or the like. For instance, this may be used for optical connection of light waveguides, e.g., an optical fiber array and a waveguide plate. FIG. 8 is illustrative of how an optical fiber array 10 is optically connected to a waveguide plate 30. As shown, optical fibers 11₁, . . . , 11₇ are optically connected, with high efficiency, to optical waveguides 31₁, . . . , 31₇ on a one versus one basis.

By use of the bilateral telecentric optical system 1, it is thus possible to make simultaneous optical connections between a plurality of optical fibers and a plurality of waveguides. For alignment of both the fibers and the waveguides, only adjustment of the bilateral telecentric optical system 1 is needed. Thus, the alignment is easily achievable. Optical waveguides having varying mode field diameters, too, may be connectable by varying the magnification of the bilateral telecentric optical system 1.

Numerical Examples 1 and 2 are given as more specific examples of the bilateral telecentric optical system 1, 1A, and 1B set up as shown in FIGS. 1 and 2.

FIG. 9 is an optical path diagram for Numerical Example 1 of the bilateral telecentric optical system 1. On the object side, the end face of an optical fiber array 10, shown at r₀, is located. The bilateral telecentric optical system 1 comprises nine lenses or, in order from the side of the object (the optical fiber array 10), two double-convex lenses, a negative meniscus lens concave on its object side, a double-convex lens, a double-concave lens, a negative meniscus lens convex on its object side, a negative meniscus lens concave on its object side, a positive meniscus lens concave on its object side and a double-convex lens. In the rear of the optical system 1, there are located an MEMS mirror array 16 indicated at r₁₉ and a turn-back mirror 19 defining an image plane indicated at r₂₀. The MEMS mirror 16 is inclined with the normal of the substrate being at an angle of 22.5° with respect to the optical axis.

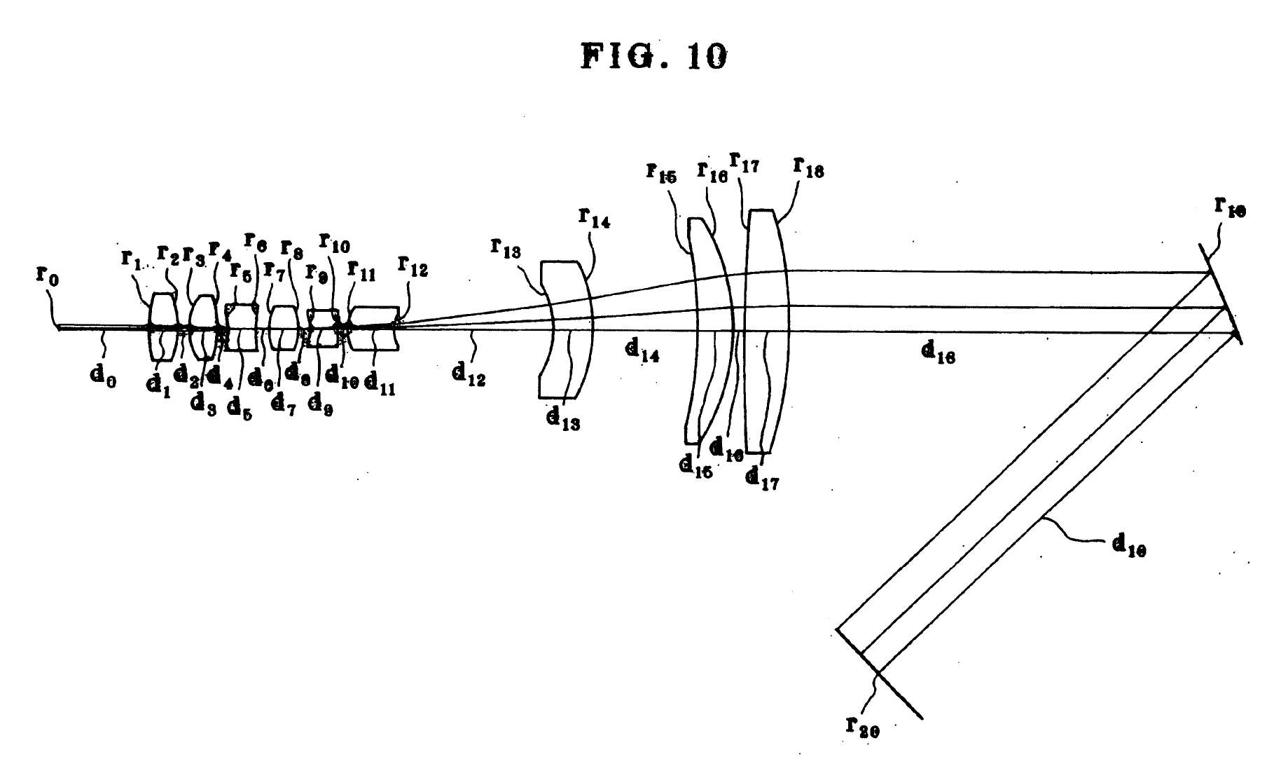

FIG. 10 is an optical path diagram for Numerical Example 2 of the bilateral telecentric optical system 1. On the object side, the end face of an optical fiber array 10, indicated at r₀, is located. The bilateral telecentric optical system 1 comprises nine lenses or, in order from its object side, two double-convex lenses, a double-concave lens, a double-convex lens, a negative meniscus lens concave on its object side, a negative meniscus lens convex on its object side, a negative meniscus lens concave on its object side, a positive meniscus lens concave on its object side and a double-convex lens. In the rear of the optical system 1, there are located an MEMS mirror array 16 indicated at r₁₉ and a turn-back mirror 19 defining an image plane indicated at r₂₀. The MEMS mirror array 16 is inclined with the normal of the substrate being at an angle of 22.5° with respect to the optical axis.

Numerical data on each numerical example are given below. Symbols used herein indicate:

NA₀: numerical aperture on the object side

β: magnification

r₀: object plane

r₁, r₂, . . . : radius of curvature of each lens surface

r₂₀: image plane

d₀: spacing between the object plane and the first lens surface

d₁, d₂, . . . : spacing between lens surfaces

d₁₉: spacing between the MEMS mirror array 16 and the turn-back mirror 19.

“MEMS” stands for the MEMS mirror array 16. It is noted that the glasses 1, 2 and 3 have the refractive indices as already mentioned, and the reference wavelength is 1.550 μm.

Numerical example 1

| | | |
|---|---|---|
| r₀ = ∞ (Object) | d₀ = 9.999660 | |
| r₁ = 13.37556 | d₁ = 3.000000 | GLASS 2 |
| r₂ = −8.60009 | d₂ = 1.200000 | |
| r₃ = 6.47030 | d₃ = 3.000000 | GLASS 2 |
| r₄ = −9.62240 | d₄ = 1.200000 | |
| r₅ = −5.21155 | d₅ = 3.000000 | GLASS 1 |
| r₆ = −40.46389 | d₆ = 1.200000 | |
| r₇ = 5.45445 | d₇ = 3.000000 | GLASS 2 |
| r₈ = −6.31041 | d₈ = 2.121958 | |
| r₉ = −3.18422 | d₉ = 3.000000 | GLASS 1 |
| r₁₀ = 32.43681 | d₁₀ = 1.200000 | |
| r₁₁ = 4.58169 | d₁₁ = 5.000000 | GLASS 2 |
| r₁₂ = 3.67509 | d₁₂ = 15.678483 | |
| r₁₃ = −9.85987 | d₁₃ = 4.678525 | GLASS 1 |
| r₁₄ = −15.78896 | d₁₄ = 11.762677 | |
| r₁₅ = −48. 51610 | d₁₅ = 4.958357 | GLASS 2 |
| r₁₆ = −22.77635 | d₁₆ = 1.200000 | |
| r₁₇ = 105.03661 | d₁₇ = 5.000000 | GLASS 2 |
| r₁₈ = −42.25490 | d₁₈ = 46.999986 | |
| r₁₉ = ∞ (MEMS) | d₁₉ = 52.073197 | |
| r₂₀ = ∞ (Image Plane) | | |

Numerical example 2

| | | |
|---|---|---|
| r₀ = ∞ (Object) | d₀ = 9.999882 | |
| r₁ = 14.78347 | d₁ = 3. 000000 | GLASS 3 |
| r₂ = −9.54881 | d₂ = 1.200000 | |
| r₃ = 6.45567 | d₃ = 3.000000 | GLASS 3 |
| r₄ = −10.56397 | d₄ = 1.200000 | |
| r₅ = −5.52042 | d₅ = 3.000000 | GLASS 1 |
| r₆ = 21.43280 | d₆ = 1.200000 | |
| r₇ = 4.35030 | d₇ = 3.460151 | GLASS 3 |
| r₈ = −5.23286 | d₈ = 1.200000 | |
| r₉ = −2.75628 | d₉ = 3.000000 | GLASS 1 |
| r₁₀ = −282.04741 | d₁₀ = 1.200000 | |
| r₁₁ = 4.55744 | d₁₁ = 5.000000 | GLASS 3 |
| r₁₂ = 3.43153 | d₁₂ = 17.302785 | |
| r₁₃ = −9.99130 | d₁₃ = 4.414133 | GLASS 1 |
| r₁₄ = −17.07494 | d₁₄ = 11.646068 | |
| r₁₅ = −45.14269 | d₁₅ = 3.976863 | GLASS 3 |
| r₁₆ = −22.07351 | d₁₆ = 1.200000 | |
| r₁₇ = 187.25014 | d₁₇ = 5.000000 | GLASS 3 |
| r₁₈ = −41.28883 | d₁₈ = 46.999986 | |
| r₁₉ = ∞ (MEMS) | d₁₉ = 52.007290 | |
| r₂₀ = ∞ (Image Plane) | | |

NA_{O} = 0.18750
β = ×15.0000

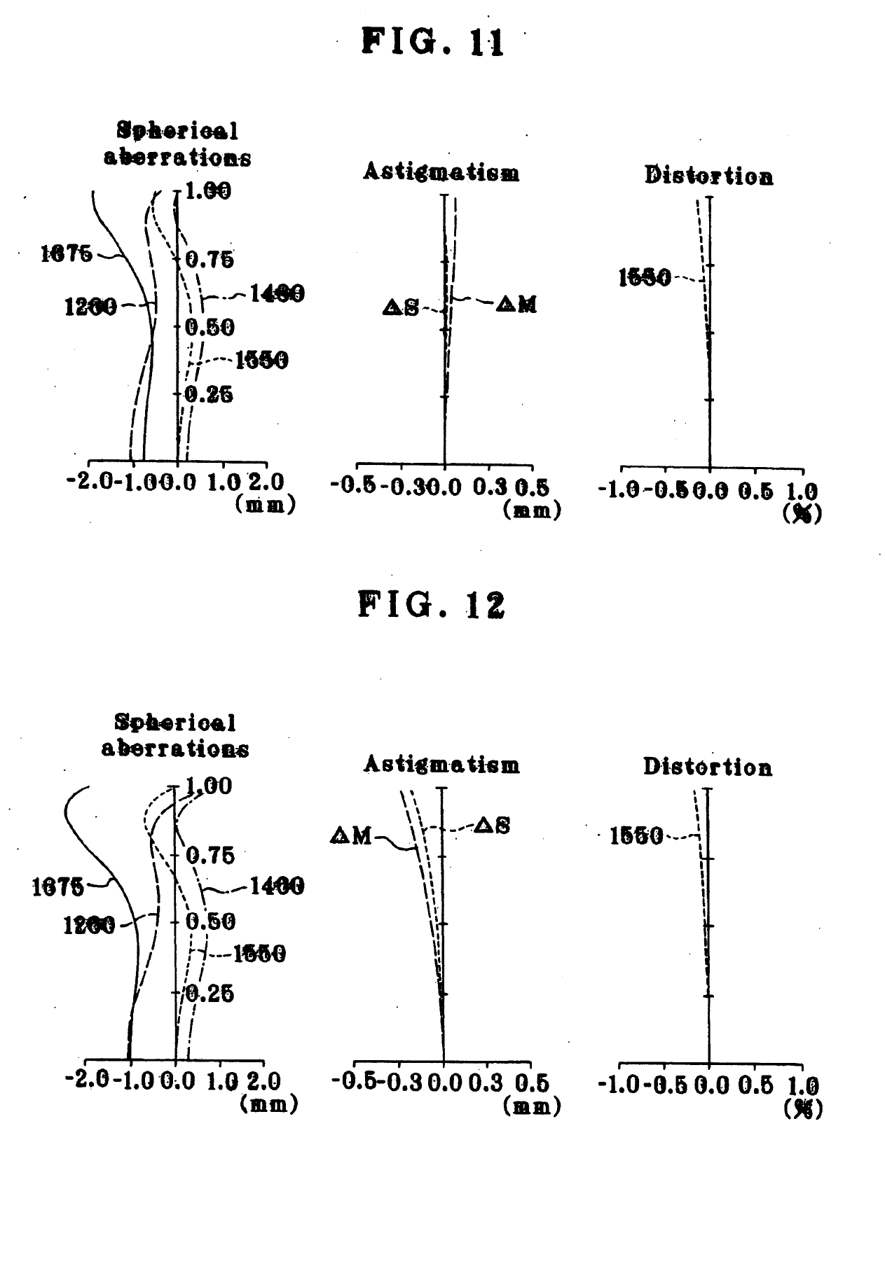

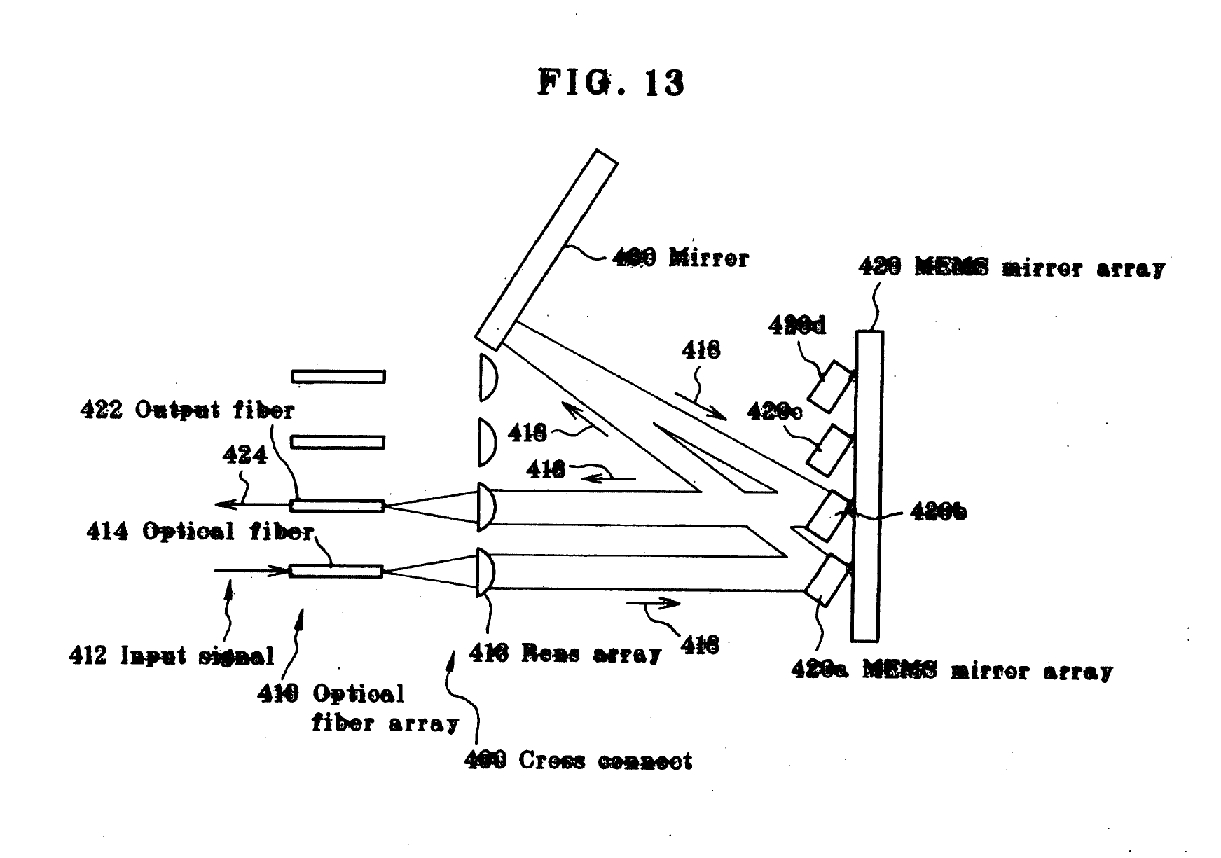

FIGS. 11 and 12 are aberration diagrams for Numerical Examples 1 and 2 on the image plane, respectively.

As can be understood from the foregoing, the connector module according to the examples of the present invention, wherein one bilateral telecentric optical system is used to optically connect at least two light beams from input optical waveguides to output waveguides, ensures that a plurality of optical waveguides can simultaneously and easily be aligned by adjustment of the bilateral telecentric optical system alone. By combined use of a plurality of vitreous materials, it is also possible to obtain an optical system for infrared light that can accommodate well to a wide wavelength-band range of 1.2 μm to 1.7 μm. The optical system used is not limited to any specific wavelength range, and so is very convenient for the user and economically favorable as well.

Harnessing refraction, the present invention dispenses with DOEs or other devices having diffraction efficiency characteristics depending on wavelength, and does not develop phenomena such as large chromatic dispersion. The present invention can also provide an optical connector module that accommodates well to a wide wavelength-band range and enables optical connections of high precision through adjustment of only one lens. Further, the present invention can provide an optical connector module ensuring that light is efficiently entered in an MEMS mirror array or the like for efficient optical connections irrespective of how an optical fiber array is located.

What we claim is:

1. An optical connector module for optical communications, used in a light wavelength range of 1.2 μm to 1.7 μm, which comprises:
an optical system for entering optical signals produced from a plurality of input optical waveguides in a plurality of output optical waveguides, wherein:
the optical system comprises a bilateral telecentric optical system, and
the optical system provides optical connections of at least two light beams from the input optical waveguides to the output optical waveguides.

2. The optical connector module for optical communications according to claim 1, which further comprises:
a mirror array comprising a plurality of mirror elements each with a variable angle of inclination, wherein:
the mirror array is located between the input optical waveguides and the output optical waveguides, and
the mirror elements with a variable angle of inclination vary a direction of reflection of the light beams from the input optical waveguides, so that depending on a change in the direction of reflection, connection to the output optical waveguides is changeable.

3. The optical connector module for optical communications according to claim 2, which further comprises:
a flat plate, on which the mirror array is located, wherein:
the flat plate is inclined and positioned at an angle with an optical axis of the bilateral telecentric optical system.

4. The optical connector module for optical communications according to claim 1, wherein:
the bilateral telecentric optical system has a magnification of 1 to 30 times inclusive.

5. The optical connector module for optical communications according to claim 1, wherein:
the bilateral telecentric optical system is an anamorphic optical system, and has a varying magnification in two directions, provided that the two directions are orthogonal to each other and to the optical axis.

6. The optical connector module for optical communications according to claim 1, wherein:
in at least one of the input optical waveguides or the output optical waveguides, the optical waveguides are packed at a maximum density while the variable mirror elements with a variable angle of inclination are packed at a maximum density.

7. The optical connector module for optical communications according to claim 3, wherein:
in at least one of the input optical waveguides or the output optical waveguides, end faces of the optical waveguides are cut obliquely at an angle with respect to optical axes of the optical waveguides to define slopes while the mirror array is inclined with respect to the slopes, wherein the mirror array is located at an angle of about 90° that the slopes make with a plane of the mirror array.

8. The optical connector module for optical communications according to claim 7, wherein the angle that the slopes make with the plane of the mirror array is within 90°±15°.

9. An optical system for infrared light, which is used in a wavelength range of 1.2 μm to 1.7 μm, and comprises:
at least two different vitreous materials, one of which satisfies condition (1) with respect to ν₁, and another of which satisfies condition (2) with respect to ν₂:
70<ν₁<120 (1)
120<ν₂<250 (2)
where ν₁ and ν₂ are Abbe number-equivalent values for the materials at 1.55 μm wavelength and defined by
ν=(n_{1.55}−1)/(n_{1.26}−n_{1.675}) (a)
where n_{1.26} is a refractive index at 1.26 μm wavelength, n_{1.675} is a refractive index at 1.675 μm wavelength, and n_{1.55} is a refractive index at 1.55 μm wavelength.

10. The optical system for infrared light according to claim 9, which satisfies conditions (1-1) and (2-1):
75<ν₁<115 (1-1)
120<ν₂<250 (2-1)

11. The optical system for infrared light according to claim 9, which satisfies conditions (1-2) and (2-2):
80<ν₁<115 (1-2)
125<ν₂<200 (2-2)

12. The optical system for infrared light according to claim 9, which further satisfies condition (3):
n₁>1.7 (3)
where n₁ is a refractive index at 1.55 μm wavelength of the material having an Abbe number-equivalent value ν₁.

13. The optical system for infrared light according to claim 9, which is a bilateral telecentric optical system.
